(19) United States
(12) Patent Application Publication
(10) Pub. No.: US 2006/0174749 A1
(43) Pub. Date: Aug. 10, 2006

(54) DRUM STRUCTURES HAVING TURN-ON DRUMHEAD TUNING AND SPHERICAL ACOUSTIC CHAMBERS

(76) Inventor: Robert Lerner, N. Bay Village, FL (US)

Correspondence Address: JOHN C. SMITH, ESQ., 2499 GLADES ROAD, SUITE 113, BOCA RATON, FL, 33431, US

(21) Appl. No.: 11/161,749

(22) Filed: Aug. 15, 2005

Related U.S. Application Data
(60) Provisional application No. 60/593,691, filed on Feb. 4, 2005.

(51) Int. Cl. G10D 13/04

(52) U.S. Cl. 84/419

(57) ABSTRACT

A turn-on tuning system which uses threaded tuning rims in place of lugs used by conventional drums, and a spherical acoustic chamber to provide both acoustic and visual improvements over prior art instruments. The turn-on tuning system uses a drum head which is secured to the drum when sandwiched between a threaded drum shell and a threaded rim. The drum is tuned by rotating the rim to increase pressure on the drumhead. A further feature of the invention is the spherical acoustic chamber which replaces the drum shell. The spherical acoustic chamber provides an enhanced audio quality, and also provides a housing for electronic equipment which may be held within the spherical chamber. In addition, the spherical chamber provides numerous visual improvements in that it allows for lighting which may be programmed for entertainment purposes.

### CROSS-REFERENCE TO RELATED APPLICATIONS

This application is related to, and claims the benefit of, the provisional patent application entitled “Drum Structures Having Lugless Drumhead Tuning and Spherical Acoustic Chambers,” filed Feb. 4, 2005, bearing U.S. Ser. No. 60/593,691 and naming Robert Lerner, the named inventor herein, as sole inventor, the contents of which is specifically incorporated by reference herein in its entirety.

### BACKGROUND OF THE INVENTION

1. Technical Field

The present invention relates to musical instruments. In particular, it relates to a new turn-on tuning mechanism for a drum structure using spherical acoustic chambers that provide both audio and visual improvements over the prior art.

2. Background

The music industry uses drums with almost every type of music. While some drums may be suitable for every type of music, other drums may be more suitable particular types of music. As a result, the wide variety of music categories has resulted in the development of many types of drums. For example, drum sets or drum kits are used by rock-and-roll bands can vary from drums used by orchestras or other musical combinations. A wide variety of drums have been developed for these various purposes, such as bongos, square drums, percussion drums, based drums, kettle drums, tom-tom drums, and tympani drums are all types of drums used in the production of many types of music. In addition to acoustic drums, many drums have also been simulated, or enhanced, by electronic devices.

Each of the many types of drums that have been developed have their own unique sound qualities. As a result, bands and orchestras typically require many types of drums to produce the various sounds required for a particular musical work. Depending on the intent of the artists, variations in acoustic qualities for particular musical instruments may improve the nature of a given musical work. It would be desirable to have a method of altering the sound quality of existing drums to create particular acoustic effects.

Another problem associated with the use of drums is that they require a substantial amount of skill and effort to properly tune. Drums are typically tuned by adjusting a series of lugs arranged around the periphery of the drum head. It would be desirable to have a method of tuning drums which took less time, did not require a high skill level, and was convenient to tune.

### SUMMARY OF THE INVENTION

The present invention provides a sphere shaped drum with a drum tuning system that uses threaded tuning rims in place of lugs used by conventional drums. A spherical acoustic chamber provides both acoustic and visual improvements over prior art instruments. The tuning system uses a drum head which is secured to a threaded drum shell with a turn-on rim. A further feature of the invention is the spherical acoustic chamber. The spherical acoustic chamber provides an enhanced audio quality, and also provides a housing for electronic equipment which may be held within the spherical chamber. In addition, the spherical chamber provides numerous visual improvements and it allows for lighting which may be programmed for entertainment purposes.

### BRIEF DESCRIPTION OF THE DRAWINGS

FIG. 1A illustrates a side view of the preferred embodiment of the invention which illustrates a drum shell with a spherical acoustic chamber attached to the drumhead.

FIG. 1B illustrates an edge view of preferred embodiment of the invention which illustrates the drumhead mounted on the drum shell with the spherical acoustic chamber.

FIG. 2A illustrates a preferred embodiment of the invention in which a drumhead is being secured to a drum shell by a rim.

FIG. 2B illustrates another preferred embodiment of the invention in which an integrated drumhead/rim combination is being secured to a drum shell.

FIG. 3 illustrates a cross-sectional view of a preferred embodiment of the invention which illustrates how the drumhead is assembled to the drum shell.

FIG. 4 is an edge cutaway view of the threaded collar of the drum shell. Also shown is the bearing edge which is integrated with the threaded collar in this embodiment.

FIG. 5 shows a spherical acoustic chamber attached to a drumhead and tuning ring.

FIG. 6 illustrates an alternative preferred embodiment in which the spherical acoustic chamber has an extension which forms the bearing edge which attaches to the threaded collar.

FIG. 7 illustrates an alternative preferred embodiment in which acoustic elements are placed inside the spherical acoustic chamber, or the interior of the drum may be contoured, to produce specific changes in the sound produced by the drum.

FIG. 8 illustrates another alternative preferred embodiment in which apertures are formed in the wall of the spherical acoustic chamber for the purpose of modifying the quality of the sound produced by the drum, and for decoration.

FIG. 9 illustrates another alternative preferred embodiment in which an interior lamp illuminates the spherical acoustic chamber from the inside.

FIG. 10 illustrates another alternative preferred embodiment in which the spherical acoustic chamber has a decorative external design.

### DESCRIPTION OF THE PREFERRED EMBODIMENT

Prior to a detailed discussion of the figures, a general overview of the system will be presented. This invention provides an improved method of tuning drumheads along with a spherical acoustic chamber which improves audio quality and provides additional visual entertainment options.

Conventional drums are tuned using a series of lugs which are mounted on the drum shell. To properly tune the drum, each of the different lugs must be carefully adjusted to provide the proper tension on the drumhead which will then provide the desired audio qualities. In the preferred embodiment, a prior art drumhead (which typically consists of the plastic sheet which the drumstick strikes and a metal tube frame that supports it) is sandwiched between the rim and the bearing edge of the drum 1. The rim and the drum have threaded surfaces which allow them to be secured together. By sandwiching the drumhead between a threaded rim and the bearing edge of a threaded drum, the drum can be acoustically tuned with equal tension on all sides. An alternative preferred embodiment provides a new drumhead mounting assembly which allows the drumhead to be threaded directly onto the threads on the drum. The new drumhead has threads that secure it to the threaded drum by gradually tightening it equally on all sides, thereby producing the proper tension and tonality. The drumhead is tuned by rotating the drumhead on the threaded section to gradually increase tension.

An important feature of the invention is the addition of a spherical acoustic chamber. The drum shell is positioned between the drumhead and the spherical acoustic chamber, unless a one-piece design is used in which the spherical acoustic chamber, the shell, and the bearing edge are molded as a single plastic piece. The spherical acoustic chamber provides an improved audio quality which gives the unique sound to whatever musical piece the musician is playing. The drumhead is then placed on the shell and secured by the rim. The shell and the rim have threaded surfaces which, when rotated, tighten the drumhead and alter the pressure on it to tune it.

In addition to the acoustic qualities produced by the invention, another important feature of the invention is that it provides a unique visual appearance. In practice, drums are often used in sets containing several independent drums are of different sizes. When multiple drums are used, the combination of different sized spherical acoustic chambers results in a unique visual impact that resembles a “molecule” structure. The spherical shape provides another advantage. Namely, due to the size of the spherical acoustic chambers, they allow additional features to be added. For example, internal lighting can be provided which can be programmed, or illuminated in response to sounds produced by the drums. Further, electronic equipment can be concealed within the spherical acoustic chamber which will allow the drum to produce electronic music rather than acoustic music. In addition to illumination, sensors within the drum can detect when the drum struck for the purpose of illuminating the drum whenever it is struck, thereby controlling the illumination with the music. As can be seen, in addition to the unique visual appearance of these drums, they can also have a variety of built-in functional equipment which will improve the performance both from an audible and visual standpoint.

It should be noted that while drums are often fabricated from materials such as wood, metal, etc. Further, different types of drums are usually fabricated from different materials. For example, wooden drum hoops are typically used on bass drums whereas, smaller drums (i.e. tom toms etc.) generally use metal rims. The drums with spherical acoustic chambers are not limited in terms of the material used to fabricate them any more than any other type of drum. As a result, these drums provide the artist with wide latitude in the materials used. The only limitation is the effect the selected materials have on the sound produced by the drum.

Having provided a general overview of the turn-on tuning and spherical acoustic chamber, we turn now to a more detailed discussion of the figures.

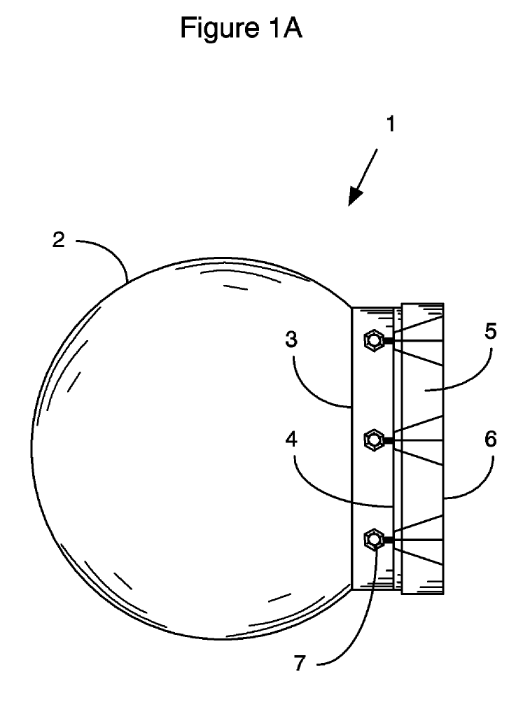

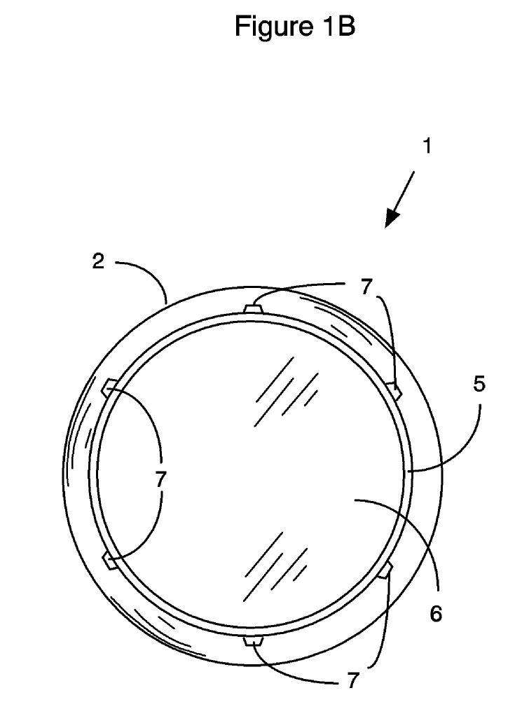

FIG. 1A illustrates a side view of the preferred embodiment of a drum 1 which uses a spherical acoustic chamber 2. In this figure, the spherical acoustic chamber 2 has an extension 3 that is secured to the drum shell 4. In turn, the prior art lugs 7 are used to secure the wooden hoop 5. The drumhead 6 is secured between the wooden hoop 5 and the drum shell 4. As can be seen from this figure, the spherical acoustic chamber 2 provides a unique new shape, and overall appearance, to the drum 1. Those skilled in the art will recognize that a complete drum set having numerous drums 1 will provide a startling visual appearance to the audience.

Those skilled in the art will recognize that the size of the sphere shaped drums provided by the invention can vary in size depending on the particular type of drum 1. It is envisioned that the spherical acoustic chamber 2 can be used with any size or type of drum 1. For example, they can be used with bongos, square drums, percussion drums, base drums, kettle drums, tom-tom drums, or tympani drums. As a result, the size of the spherical acoustic chamber 2 will vary over a wide range. Diameter sizes of the spherical acoustic chamber 2 may typically range from two foot six inches to one foot one inch. Likewise, in the preferred embodiment the drum shell 4 may typically be sized at approximately five inches. The foregoing sizes are suggestive of how the invention may be implemented. However, it is understood that size is not critical and can vary substantially depending on the type of drum and the size of the drumhead 6.

In addition to size, the designer has a substantial number of options in terms of the material used to construct the drum 1. It can be made from any suitable clear or colored material, such as wood, metal, glass, plastic (including glow-in-the-dark plastic), resin, polyethylene, polypropylene, etc. In fact, any material which has suitable acoustic and visual properties can be used. In addition, the spherical acoustic chamber 2 can also be decorated with colors, images, lettering, etc., such that any number of visual themes can be presented to the audience.

In addition to variations in the size of the spherical acoustic chamber 2 and the type of material used to fabricate it, the spherical acoustic chamber 2 can also vary in shape. For ease of illustration, a spherical acoustic chamber 2 has been used to illustrate the invention. While a spherical acoustic chamber 2 is shown in the figure, those skilled in the art will recognize that alternative shapes can be used to implement this invention. The shapes can perfect spheres, oblate spheroids, elliptical spheroids, etc. The acoustic chamber can even have freeform shapes, irregular shapes, or even the shapes of characters. The only restriction is that the spherical acoustic chamber 2 be able to attach to the particular drum shell 4 in question, unless it is fabricated from a one piece mold (i.e., plastic chamber, shell and bearing edge.) For ease of discussion, the term “spherical acoustic chamber” shall be used in this specification to refer to any of the foregoing shapes.

FIG. 1B illustrates an end view of a preferred embodiment of the invention which illustrates the drumhead 6 mounted on the wooden hoop 5 which is in turn attached to spherical acoustic chamber 2. Also shown in this figure are optional lugs 7. In the prior art, lugs 7 would have been used to tune the drum 1. In the embodiment shown herein, the lugs 7 provide ornamental value, but the drum 1 does not require lugs 7 to function or for tuning purposes. If lugs 7 are used, they can be attached in a variety of ways. For example, they can be formed as part of the wall of the acoustic chamber 2 as integral attachments to the chamber, or as a conventional lug 7 secured to the drum shell 4, etc.

For ease of illustration, this figure shows the spherical acoustic chamber 2 as having a wider diameter than the drum shell 4. However, this is in fact not required to implement the invention. The diameter of the spherical acoustic chamber 2 may be the same as the diameter of the drum shell 4, or even less. Those skilled in the art will recognize that the spherical acoustic chamber 2 can vary in size to suit the audio and visual design goals of a particular drum set.

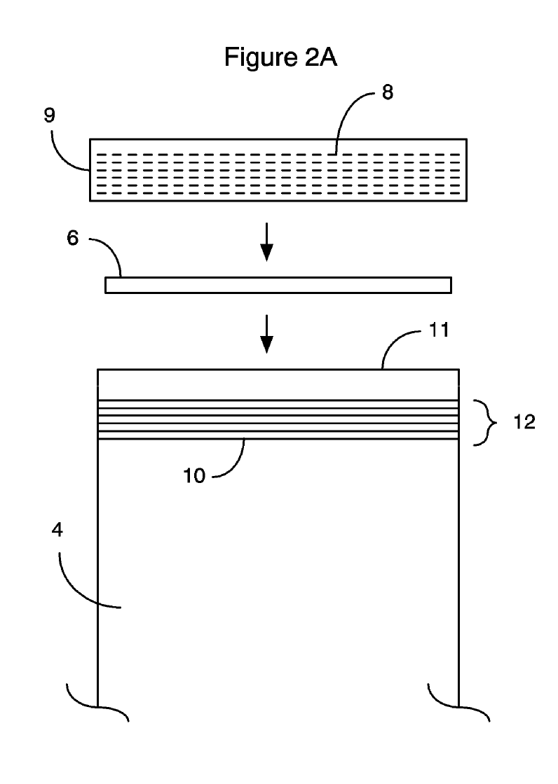

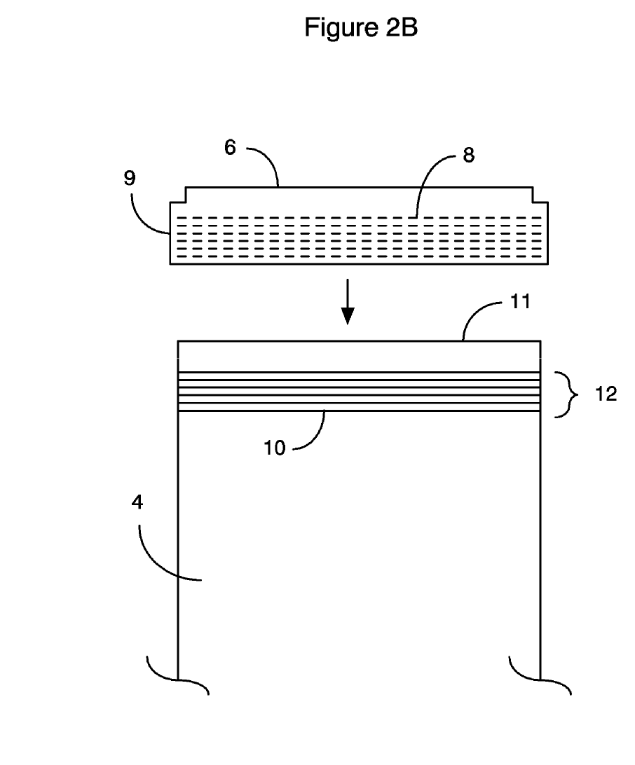

FIG. 2A illustrates a preferred embodiment of the drum 1 as used by the invention. The drumhead 6 is attached to a rim 9. This figure also illustrates the location of female threads 8 which are located on the inside of the rim 9. When the drumhead 6 and rim 9 are attached to the drum shell 4, they are secured by threading the female threads 8 onto corresponding male threads 10 on the drum shell 4. In the preferred embodiment, male threads are formed in a threaded collar 12 which is attached to the body of drum shell 4. Also shown in this figure is bearing edge 11. When rim 9 is threaded onto corresponding male threads 10, with a drumhead in place, bearing edge 11 limits the distance which the tuning rim 9 can be threaded. It is preferred that rim 9 be fabricated from metal. However, any other suitable material may be used. Depending on how much rim 9 is tightened to the drum shell 4, the pressure on the drumhead 6 will vary, thereby tuning the drumhead 6 equally on all sides.

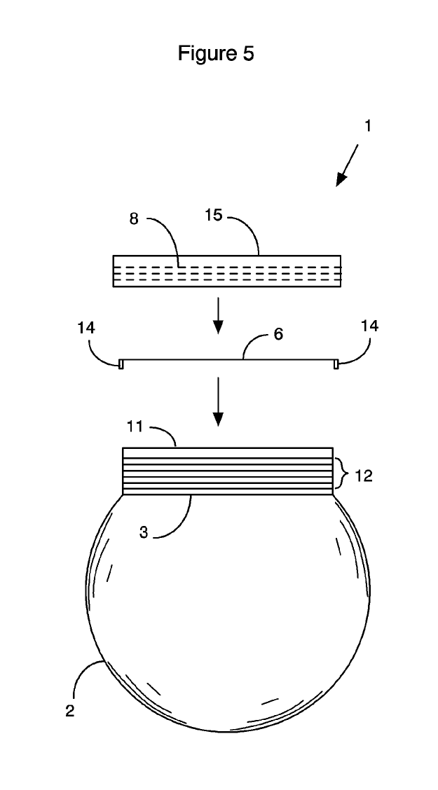

FIG. 2B illustrates an alternative preferred embodiment of the drum 1 as used by the invention. In this embodiment, that drumhead 6 and the rim 9 are fabricated as a single component. This is easily accomplished by expanding the tube ring 14 (illustrated in FIG. 5) such that it has a collar with a threaded inner surface which forms the rim 9. This figure illustrates the location of female threads 8 which are located on the inside of the drumhead 6. When the drumhead 6 is attached to the drum shell 4, it is secured by threading the female threads 8 onto corresponding male threads 10 on the drum shell 4. In the preferred embodiment, male threads are formed in a threaded collar 12 which is attached to the body of drum shell 4. Also shown in this figure is bearing edge 11. When tube frame 9 is threaded onto corresponding male threads 10, bearing edge 11 limits the distance which metal rim 9 can be threaded. It is preferred that rim 9 be fabricated from metal. However, any other suitable material may be used. Of course, those skilled in the art will recognize that it does not matter whether the metal threads 10 or the female threads 8 are on the threaded collar or the rim 9. It is only important that they can be joined together to secure the drumhead 6 to the drum 1, and to tune the drum 1 by tightening the drumhead 6.

Typically, threaded collar 12 would be relatively small, such as 1.5 inches. However, this can vary depending on the material used, and on the size of the drum 1. Likewise, the preferred embodiment envisions the threaded collar being fabricated from metal. However, any other alternative material can be used provided that it is suitable for its intended purpose.

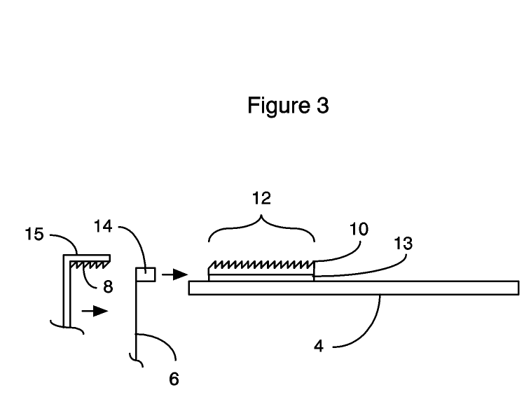

FIG. 3 is a cross-sectional view of a preferred embodiment of the invention which illustrates how the drumhead 6 is assembled to the drum shell 4. In this figure, the drumhead 6 being mounted on the drum shell 4. As shown in this figure, the male threads 10 are secured to the drum shell 4 with a pliable gasket 13 positioned between the metal male threads 10 and the drum shell 4 which is typically fabricated from wood. During assembly, the metal tube frame 14 is shown attached to the drumhead 6 and overlaps the edge of the drum shell 4. Once the drumhead 6 is attached to the drum shell 4, the tuning ring 15 is threaded onto the male threads 10 until the drumhead 6 is securely attached to the drum shell 4.

As was the case with other components of the system, the preferred embodiment envisions a tube frame 14 which is fabricated from metal. However, those skilled in the art will recognize that any suitable material can be used so long as it is suitable for its purpose. Tube frames are known in the art.

This embodiment eliminates the need to tune the drum 1 with tuning lugs, as is done in the prior art. In this embodiment, the drumhead 6 is tuned by adjusting the tightness of the tuning ring 15 and the male threads 10. This provides an easier and more convenient way of adjusting the drumhead 6 tension. In summary, this turn-on drum tuning embodiment is fabricated from metal (or other suitable material. Tuning ring 15 is designed to threaded over the outside of the drum shell 4. This eliminates the need for lugs to be used and affords easier and more precise tuning of the drum 1. This system may be used for both acoustic and electronic drums.

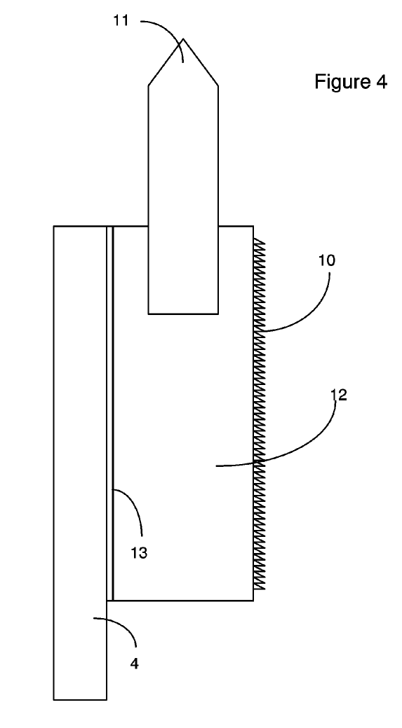

FIG. 4 illustrates a cutaway view of a preferred embodiment of the invention in which the bearing edge 11 is integrated with the threaded collar 12. It is the bearing edge 11, pressing against the drumhead 6, which tunes the drum 1. As the rim 9 is tightened, the bearing edge 11 increases the pressure on the drumhead 6 to change the acoustic quality of the drum 1. Also shown this figure is gasket 13, which reduces noise between the threaded collar 12 and the drum shell 4. Any suitable means, such as screws, adhesive, etc., can be used to attach the gasket 13 to the threaded collar 12 and the drum shell 4.

In FIG. 5, a preferred embodiment of a spherical acoustic chamber 2 is shown being attached to a drumhead 6 and tuning ring 15. In this embodiment, the drumhead 6 is secured to a tube frame 14. The tube frame 14 is mounted over the bearing edge 11, and then is secured in place by threading tuning ring 15 onto threaded collar 12. The dashed lines 8 indicate the threading inside the tuning ring 15 which mates with threaded collar 12.

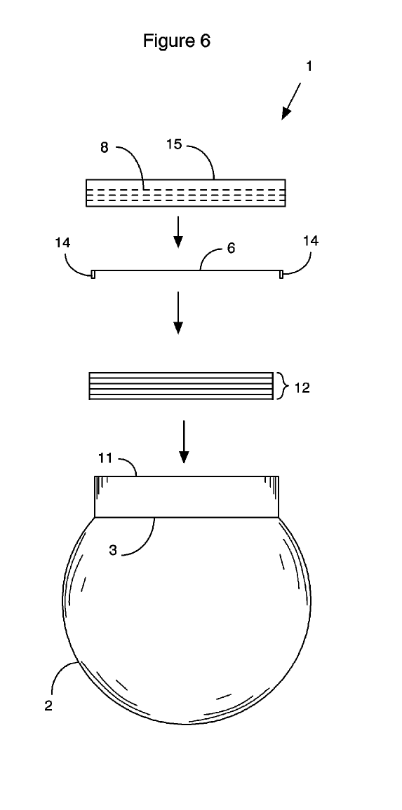

FIG. 6 is an alternative preferred embodiment of the invention. In this embodiment, the spherical acoustic chamber 2 has an extension 3 which is sized to attach to the threaded collar 12. In addition, the edge of the extension 3 forms the bearing edge 11. The drumhead 6 and the tuning ring 15 attach in the same manner as before.

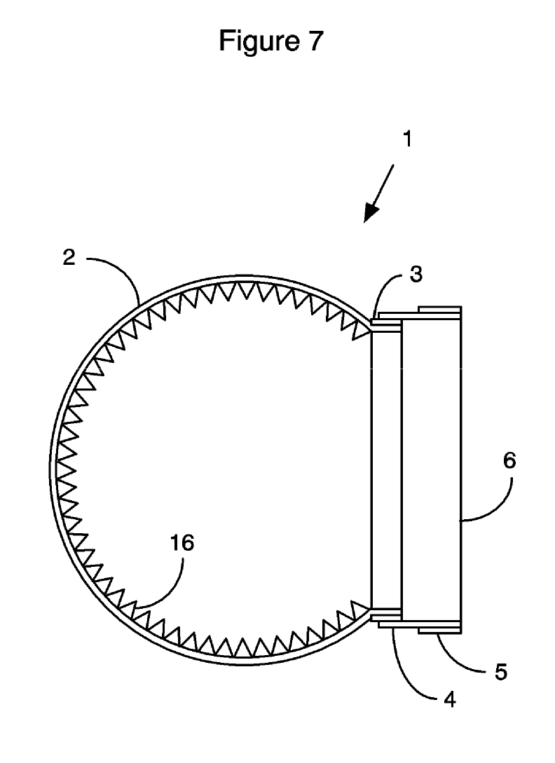

FIG. 7 illustrates a cross-sectional side view of an alternative preferred embodiment of the spherical acoustic chamber 2. In this embodiment, optional acoustic elements 16 are placed inside the spherical acoustic chamber 2 of the drum 1 to produce specific changes in the sound produced by the drum 1. Alternatively, the acoustic elements 16 can be an integral part of the spherical acoustic chamber 2.

For ease of illustration, acoustic elements 16 are illustrated as having simple conical shapes. However, those skilled in the art will recognize that the acoustic elements 16 can take any shape having peaks and valleys to create a desired acoustic effect. Likewise, the material used to fabricate the acoustic elements 16 can vary based on the desired acoustic effect. For example, a soft foam material may be used to soften or dampen the sound, while a harder material may be used to intensify certain sound effects. As a result, the amount of acoustic elements 16 used by a particular drum 1, as well as the material used to fabricate it, will vary depending on the intended use of the drum 1. For example, drums used by symphony orchestras may require a substantially different sound than a drum used by a heavy metal rock band.

While the acoustic elements 16 can be permanently mounted inside the spherical acoustic chamber 2, or be an integral part of the spherical acoustic chamber 2. Those skilled in the art will recognize that they can also be removably attached to allow the musician to remove some or all of the acoustic elements 16 for a particular performance, and reattach some or all of the acoustic elements 16. This can be accomplished in a variety of ways. For example, the acoustic elements 16 can be attached by adhesive, by double stick tape, by snap on attachments, or by any other suitable means. By allowing the acoustic elements 16 to be removably attached, the musician has much greater flexibility in what can be accomplished with that particular instrument.

Another way to alter the sonic performance of the drum 1 is to vary the materials which the spherical acoustic chamber 2 is fabricated from. For example, the spherical acoustic chamber 2 can be manufactured from material such as plastic or fiberglass which will result in one type of sound. Likewise, it can be manufactured from other materials such as metal or wood which will produce a different type of sound. When fabricating the spherical acoustic chamber 2, it should be noted that even when using a particular material, for example wood, the sound quality will vary based on a variety of factors such as thickness, wood density, wood type, etc.

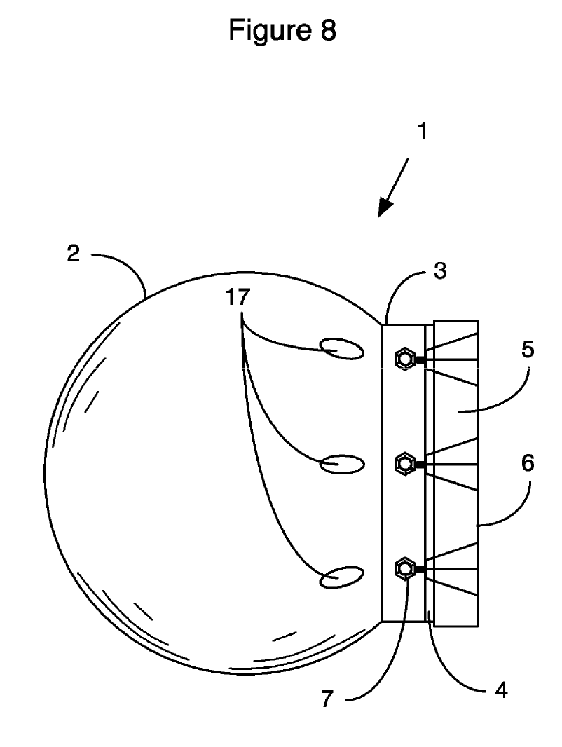

FIG. 8 illustrates another alternative preferred embodiment of the spherical acoustic chamber 2. In this embodiment, apertures 17 are formed in the wall of the spherical acoustic chamber for the purpose of modifying the quality of the sound produced by the drum 1. For ease of illustration, the apertures 17 are illustrated having simple oval shapes. However, those skilled in the art will realize that the shape of the apertures 17 can vary depending on the effect they may have on the sound quality produced by the drum 1. Likewise, the shape of the apertures 17 can also vary based on their intended appearance.

For ease of discussion, each of the components of the drum are shown and discussed as discrete elements. However, those skilled in the art will recognize that many elements can be molded as a single unit to simplify the manufacturing process. Likewise, the drums may or may not use the turn-on tuning system. For example, if a one piece plastic molded drum is used, then lugs may be connected to the spherical acoustic chamber? Conversely, if the system is used on a one piece molded drum (i.e. plastic bearing edges with no wooden shell) then an additional lip or collar area would be needed as to accommodate the threads.

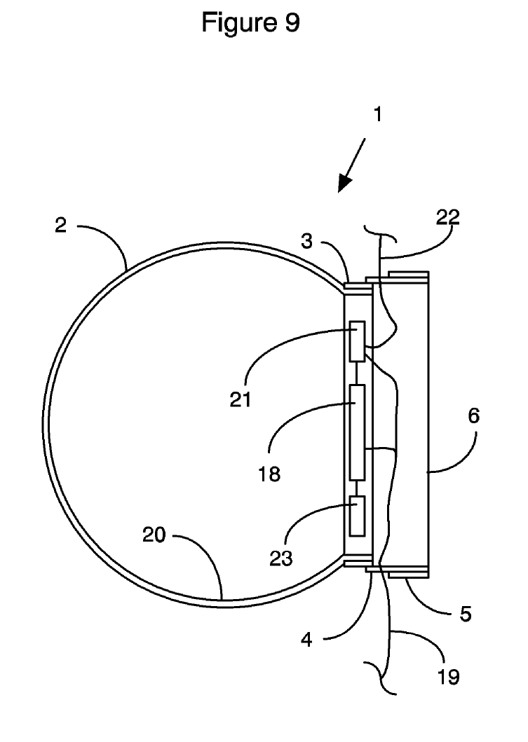

FIG. 9 illustrates another alternative preferred embodiment in which an interior lamp 18 illuminates the spherical acoustic chamber 2 from the inside. The interior lamp 18 is powered from a conventional power source (not shown) via power cord 19 which connects the interior lamp 18 to the power source. Also shown this figure is optional lamp controller 21, optional lamp controller signal line 22, and optional sensor 23.

Illumination of the interior lamp 18 can be controlled in a variety of ways. For example, the interior lamp 18 in each drum 1 can remain in the power-on condition throughout a performance such that all of the drums are illuminated. Likewise, it is possible to switch some interior lamps 18 off in a given drum 1 set so that only pre-selected drums will be illuminated. Further, it is possible to dynamically control the drum 1 interior lamp 18 with optional lamp controller 21 and optional lamp controller signal line 22. If optional lamp controller 21 is used, it can be preprogrammed, either alone or in coordination with other drums 1 such that the drums 1 turn off their interior lamps 18 in a predetermined pattern. The sequence of interior lamp 18 illumination can be permanently stored in the lamp controller 21, it can be controlled remotely via lamp controller signal line 22, or it can have the sequence which is downloaded to a storage device in the lamp controller 21. The ability to manipulate illumination of the drums 1 allows the artist to adjust the illumination to suit a particular performance.

In addition to the preceding, the lamp controller 21 can also incorporate a sensor 23 to determine when a drum 1 has been struck by the musician. The lamp controller 21 can incorporate software which will allow the lamp controller 18 to control, using input data from sensor 23, illumination of the drum 1 such that it is synchronized with the sound being produced by the drum 1. Illumination can even be varied based on the intensity of the impact on the drum 1.

Those skilled in the art will recognize that lamp controller signal line 22 is illustrated as a physical signal line, however, it can just as easily be implemented as a wireless connection using a variety of available technologies. In addition, those skilled in the art will recognize that a lamp controller 18 can also be fabricated with sufficient intelligence to allow musicians to dynamically switch from one method of illumination to another via switches, remote control devices, etc.

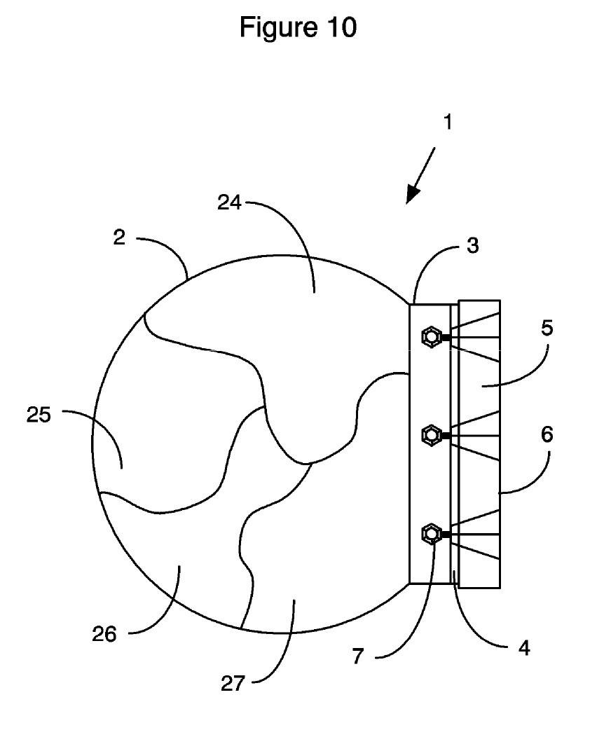

FIG. 10 illustrates another alternative preferred embodiment in which the spherical acoustic chamber 2 has a decorative external design which may incorporate any aesthetic theme. In this example, a pattern is produced by different colored segments 24-27. For ease of illustration, a simple pattern is shown in this figure. However, those skilled in the art will recognize that any aesthetic treatment can be used. The pattern can be a map of the globe, an individual's image, a photographic image, a reproduction of artwork, or any aesthetic treatment which is suitable for a particular performance. It is even possible to have removable aesthetic treatments which can be changed from one show to another.

The advantages of the embodiments of FIGS. 9-10 can be combined in a variety of ways. The interior lamp 18 can enhance the decorative external design by illuminating the drum 1 from the inside. Further, the interior lamp 18 does not have to be limited to conventional white light. For example, the interior lamp 18 can be an ultraviolet lamp designed to react with a decorative design that uses phosphorescent paint. Likewise, the drum can also be illuminated by colored light, laser light, or a projected image. This extends the range of possibilities for illumination of the drum 1. The drum 1 does not have to be used solely with one type of paint or one type of illumination. For example, combinations of conventional paint and phosphorescent paint can be used in combination with an interior lamp 18 which produces white light (e.g., the normal visual light spectrum), a colored light, laser lights, and/or ultraviolet light (e.g., commonly referred to as a black light). The availability of multiple types of illumination can be taken advantage of by the lamp controller 21 which may be programmed to produce an entertaining light show coordinated with a particular musical work.

This process enables an image to change during the performance. For example, when the white light is on, a first image applied to the spherical acoustic chamber 2 may be viewed. If phosphorescent paint is used to apply a second image on the spherical acoustic chamber 2, it will not be seen unless the interior lamp 18 containing the ultraviolet bulb is activated. As a result, one image can be displayed when only white light is applied, a second image can be displayed when only the ultraviolet light is applied, and a third image can be displayed when both white light and ultraviolet light is applied. In addition, combination of white light and black light can be enhanced by the addition of independent colored lights, laser lights and/or projected images to expand the capability of the lamp controller 21 to provide entertainment via the drum 1. This provides flexibility for the artist in designing an entertaining program which combines both music and visual entertainment.

While the invention has been described with respect to a preferred embodiment thereof, it will be understood by those skilled in the art that various changes in detail may be made therein without departing from the spirit, scope, and teaching of the invention. For example, the spherical acoustic chamber can be used with a convention lug-based tuning system. Likewise, the turn-on tuning system provided herein may be used on conventional drums. Accordingly, the invention herein disclosed is to be limited only as specified in the following claims.

I claim:

1. A drum, further comprising:
a spherical acoustic chamber;
a threaded collar;
means to attach the spherical acoustic chamber to the threaded collar;
a drumhead;
a tuning ring, the tuning ring threadably engaged with the threaded collar such that by rotating the tuning ring, tension on the drumhead is adjusted and the drum is tuned.

2. A drum, as in claim 1, wherein is spherical acoustic chamber is fabricated from wood, metal, plastic, fiberglass, or combinations thereof.

3. A drum, as in claim 1, wherein a threaded rim is used as the means to attach the drumhead to the threaded collar.

4. A drum, as in claim 3, wherein rotation of the threaded rim on the threaded collar sandwiches the drumhead in between and increases tension on the drumhead;
Whereby the drumhead is tuned by rotating the drumhead on the collar.

5. A drum, as in claim 1, further comprising:
at least one aperture in the spherical acoustic chamber, having a size sufficient to alter the audio quality of the sound produced by the drum.

6. A drum, as in claim 1, further comprising:
at least one acoustic component inside the spherical acoustic chamber, the acoustic component having contours that alter acoustics when the is drum struck.

7. A drum, as in claim 6, wherein the acoustic component is fabricated from material that will soften the sound produced by the drum.

8. A drum, as in claim 6, wherein the acoustic component is fabricated from material that will sharpen the sound produced by the drum.

9. A drum, as in claim 1, further comprising an interior lamp.

10. A drum, as in claim 9, further comprising means to control activation of the interior lamp.

11. A drum, as in claim 10, further comprising means to manually activate the interior lamp.

12. A drum, as in claim 10, further comprising:
a lamp controller to dynamically control activation of the interior lamp;
whereby, the interior lamp is activated or de-activated during the course of a musical production.

13. A drum, as in claim 12, further comprising:
the lamp controller has means to execute a preprogrammed set of commands to control activation and de-activation of the interior lamp.

14. The drum, as in claim 12, further comprising:
a lamp controller signal line to supply control signals to the lamp controller;
Whereby the lamp controller can be dynamically controlled by signals input via the lamp controller signal line.

15. A drum, as in claim 14, wherein the lamp controller signal line is a wireless connection.

16. A drum, as in claim 12, further comprising:
a sensor, connected to the lamp controller, and providing input data to the lamp controller that is used by the lamp controller to control illumination of the interior lamp.

17. A drum, as in claim 12, further comprising:
an aesthetic design on the spherical acoustic chamber which is illuminated by the interior lamp.

18. A drum, as in claim 17, wherein the interior lamp produces white light, ultraviolet light, colored light, laser light, internal image projection or a combinations thereof.

19. A drum, as in claim 18, wherein the aesthetic design on the spherical acoustic chamber is made from materials that react white light, violet light, or both when illuminated by the interior lamp.

20. A drum, as in claim 19, further comprising:
a plurality of light sources to independently control activation of white light, ultraviolet light, colored light, laser light and/or projected images;
at least one light source illuminating a first image;
at least a second light source illuminating a second image;
whereby multiple images can be dynamically presented by illuminating the aesthetic design with a combination of light sources.
